(19) United States
(12) Patent Application Publication
(10) Pub. No.: US 2014/0082682 A1
(43) Pub. Date: Mar. 20, 2014

(54) SMART SET-TOP BOX AND OPERATING METHOD FOR PROVIDING SMART SERVICE AND DIGITAL TELEVISION SERVICE USING DEFAULT MEDIA PLAYER INCLUDED IN SINGLE OPERATING SYSTEM

(71) Applicants: Su Kyoung CHOI, Bucheon-si (KR); Gun Ho HONG, Seoul (KR); Won Ey LEE, Anyang-si (KR); Min Wook Park, Seoul (KR); Jin Young SHIN, Namyangji-si (KR); Dae Seok RYU, Yongin-si (KR)

(72) Inventors: Su Kyoung CHOI, Bucheon-si (KR); Gun Ho HONG, Seoul (KR); Won Ey LEE, Anyang-si (KR); Min Wook Park, Seoul (KR); Jin Young SHIN, Namyangji-si (KR); Dae Seok RYU, Yongin-si (KR)

(73) Assignee: LG CNS CO., LTD, Seoul (KR)

(21) Appl. No.: 13/438,675

(22) Filed: Apr. 3, 2012

(30) Foreign Application Priority Data
Sep. 22, 2011 (KR) 10-2011-0095512

(51) Int. Cl. H04N 21/472

(52) U.S. Cl. CPC H04N 21/47202
USPC 725/100

(57) ABSTRACT

A method of playing back media data in a single operating system that supports a smart service and digital television (DTV) service is provided. The method includes loading the single operating system that supports the smart service and the DTV service, receiving, by a default media player included in the single operating system from an application, a request for playback of a target media data, determining a type of an identifier (ID) of the target media data, selecting, based on the type of the ID of the target media data, one player from among a video-on-demand (VOD) player and a DTV player different from the default media player, and playing back the target media data by the selected player.

### CROSS-REFERENCE TO RELATED APPLICATION

This application claims the benefit under 35 U.S.C. §119 of Korean Patent Application No. 10-2011-0095512, filed on Sep. 22, 2011, in the Korean Intellectual Property Office, the disclosure of which is incorporated herein by reference.

### BACKGROUND

1. Field of the Invention

The present invention relates to a smart set-top box (STB) and an operating method thereof, and more particularly, to a smart STB and an operating method that may provide varied services using a default media player in a single operating system in addition to a smart service and a digital television (DTV) service.

2. Description of the Related Art

A set-top box (STB) is a device that receives a signal from an external side via an Ethernet cable, a receiving antenna for a satellite wave or a ground wave, a coaxial cable, a telephone line, a very high frequency/ultra high frequency (VHF/UHF) antenna, and the like, and appropriately converts the received signal so as to display corresponding contents on a television (TV) through a connection with the TV. Here, the STB may be included in the TV or may be a separate device.

A digital TV (DTV) service may be a service providing users with broadcast contents having a high definition and a high quality audio, using a broadcast signal compressed into a digital form. A smart service may be a service that enables downloading of varied applications from an application market and executing of the downloaded applications.

At present, the smart service may be provided through smart phones, tablet personal computers (PCs), and the like, in various forms, and the smart service may also be provided via TVs. In this example, a technology that controls a smart service and a DTV service provided via the TV using a single operating system may be required.

Most Java® applications for interactive TVs may be implemented based on the open cable application platform (OCAP), the advanced common application platform (ACAP), the multimedia home platform (MHP), and the globally executable MHP (GEM). Java® is registered trademark of ORACLE AMERICA, INC. However, a basic knowledge for a digital service may be required to implement the Java® applications for interactive TVs in an environment including a great number of application program interfaces (APIs). Therefore, most Java® applications for interactive TVs have not been commonly utilized. Conventionally, the number of Android™-platform-based applications has dramatically increased, and knowledge for operating the Android™ platform may be readily accessible. Android™ is a registered trademark of Google Inc. Accordingly, many attempts are being made to provide a digital broadcasting terminal device based on an Android-platform.

### SUMMARY

According to an aspect of the present invention, there is provided a method of playing back media data in a single operating system that supports a smart service and digital television (DTV) service, the method including loading, in a memory, the single operating system that supports the smart service and the DTV service, receiving, by a default media player included in the single operating system from an application, a request for playback of a target media data, determining, by the default media player, a type of an identifier (ID) of the target media data, selecting, by the default media player based on the type of the ID of the target media data, one player between a video-on-demand (VOD) player and a DTV player different from the default media player, and playing back the target media data by the selected player.

The ID of the target media data may include a uniform resource identifier (URI).

The selecting may include selecting one player from among the DTV player, the VOD player, and a Stagefright player, based on the type of the ID of the target media data.

The method may further include providing a result of the playback of the target media data to a DTV stack using a binder driver included in a kernel of the single operating system when the target media data is played back by the DTV player.

The binder driver included in the kernel of the single operating system may perform an inter-process communication (IPC) mechanism.

The target media data may be one of media data or a flash file received through a VOD channel or a DTV channel.

The method may further include utilizing a DTV hardware abstraction layer (DTV HAL) for communication between a DTV service function and a security service function included in the DTV stack.

The determining may include determining the type of the ID of the target media data by parsing a predetermined front portion or a predetermined back portion of the ID.

According to another aspect of the present invention, there is provided a method of managing an event associated with playback in a single operating system that supports a smart service and a DTV service, the method including receiving a playback request, by a default media player included in the single operating system from an application that requests playback of VOD data, transmitting the playback request, by the default media player to a VOD player different from the default media player, playing back, by the VOD player, the VOD data provided from a playback server, and broadcasting, by the default media player, information associated with content of an event associated with the playback of the VOD data, in response to the event occurring.

The broadcasting may include inserting information associated with the content of the event into an Intent class.

The information associated with the content of the event may indicate termination of playback of the VOD data or error in reception of the VOD data.

The information associated with the content of the event may indicate information associated with whether conversion of a channel of the VOD data is successfully performed or a cause of failure in channel conversion.

An authority to receive the information associated with the content of the event may be assigned to the application.

According to still another aspect of the present invention, there is provided a method of playing back media data in a single operating system that supports a smart service and a DTV service, the method including loading, in a memory, the single operating system that supports the smart service and the DTV service, obtaining, by an application, VOD asset information from a VOD catalogue server, providing, by the application to a default media player included in the single operating system, an ID indicating VOD data, in response to obtaining of the VOD asset information, and selecting, by the default media player, a VOD player different from the default media player, based on the ID, so that the selected VOD player is driven.

The method may further include obtaining, by the VOD player, a list of transport stream IDs, and receiving, by the VOD player, corresponding VOD data from a playback server based on a transport stream ID, and decoding the received VOD data.

According to yet another aspect of the present invention, there is provided an apparatus for playing back media data in a single operating system that supports a smart service and a DTV service, the apparatus including a memory in which the single operating system that supports the smart service and the DTV service is loaded, and a processor to receive, by a default media player included in the single operating system, a request for playback of target media data from an application, and to determine a type of an ID of the target media data, and the processor selects one player between a VOD player and a DTV player different from the default media player based on the type of the ID of the target media data, and plays back the target media data using the selected player.

Embodiments of the present invention may readily develop and drive an application merely using an application program interface (API) provided by a well-known operating system, for example, an Android™ operating system.

Embodiments of the present invention may not require a great amount of knowledge associated with television (TV) standards to develop and drive an application.

Embodiments of the present invention may support a smart service and a DTV service using a single operating system, and may effectively reuse a DTV stack that provides the DTV service.

Additional aspects, features, and/or advantages of the invention will be set forth in part in the description which follows and, in part, will be apparent from the description, or may be learned by practice of the invention.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a configuration of a smart set-top box (STB) that provides a digital television (DTV) service along with a smart service according to an embodiment of the present invention;

FIG. 2 is a block diagram illustrating a smart STB according to an embodiment of the present invention;

FIG. 3 is a diagram illustrating a configuration of a system including a well-known Android™ operating system.

FIG. 4 is a diagram illustrating an architecture of an Android™ DTV hardware abstraction layer (DTV HAL) according to an embodiment of the present invention;

FIG. 5 is a flowchart illustrating a method of providing both a DTV service and a smart service according to an embodiment of the present invention;

FIG. 6 is a block diagram illustrating a smart STB according to an embodiment of the present invention;

FIG. 7 is a diagram illustrating a process that plays back video-on-demand (VOD) media data using a VOD player different from a default media player in an operating system according to an embodiment of the present invention;

FIG. 8 is a diagram illustrating a process that selects, by a default media player, an appropriate player based on an identifier (ID) of media data, and plays back the media data using the selected player according to an embodiment of the present invention;

FIG. 9 is a diagram illustrating a process that plays back VOD media data using a uniform resource identifier (URI) according to an embodiment of the present invention; and

FIG. 10 is a diagram illustrating a process that acquires service information through a content provider according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

A digital television (DTV) service may be a service providing broadcast content having a high-definition and a high quality audio using a broadcast signal compressed into a digital form, which is different from a conventional analog service. The DTV service may provide a greater amount of information using digital signals, when compared to the analog service and thus, may provide a data service. According to the DTV service, users may be provided with an electronic program guide (EPG) service that informs the users of a TV program broadcasting time, information associated with cast members, and the like, and a video on demand (VOD) service that enables the users to select and view a desired program, at a desired time. To provide the DTV service, a set-top box (STB) that restores the broadcast signal compressed into a digital form to an original image and an original audio signal may be required.

A smart service may be a service that enables downloading of varied applications from an application market, for example, App Store °, Android™ Market, Blackberry® App World®, and the like, and enables executing of the downloaded applications. App Store is a registered trademark of Apple Computer, Inc., and Blackberry and Blackberry App World are registered trademarks of Research In Motion Limited. The applications may refer to various programs executed based on an operating system. Examples of the application may include an Internet browser, Google® maps, You Tube®, widgets, and the like, and there may be varied types of applications. Google and You Tube are registered trademarks of Google Inc. App Store is an online application market, provided by Apple, from which iOS applications may be downloaded for and/or without a fee. Android™ Market is an online application market, managed by Google®, for Android™ applications. A platform for the smart service may be, for example, an Android™-based open platform.

Embodiments of the present invention may provide a smart STB that is able to provide a DTV service and a smart service in a single operating system. That is, a user may be able to use both the DTV service and the smart service in a single operating system using a single device, for example, the smart STB.

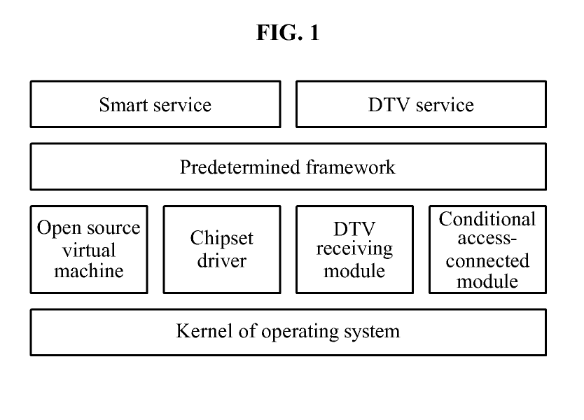

FIG. 1 illustrates a configuration of a smart STB providing a DTV service along with a smart service according to an embodiment of the present invention.

The smart STB may have varied hardware configurations and varied software configurations. FIG. 1 shows the configuration of the smart STB that provides both the DTV service and the smart service.

The smart STB may include an Android™ operating system, and may utilize various operating systems. For example, an Android™ operating system-based Linux® kernel may be included. Linux is a registered trademark owned by William R. Dell Croce, Jr. of 33 S now Hill St. Boston MASSACHUSETTS 02113. The smart STB may include an open source virtual machine, a chipset driver, a DTV receiving module, and a conditional access module. The smart service and the DTV service may be provided based on a framework corresponding to an operating system, for example, a well-known Android™ framework.

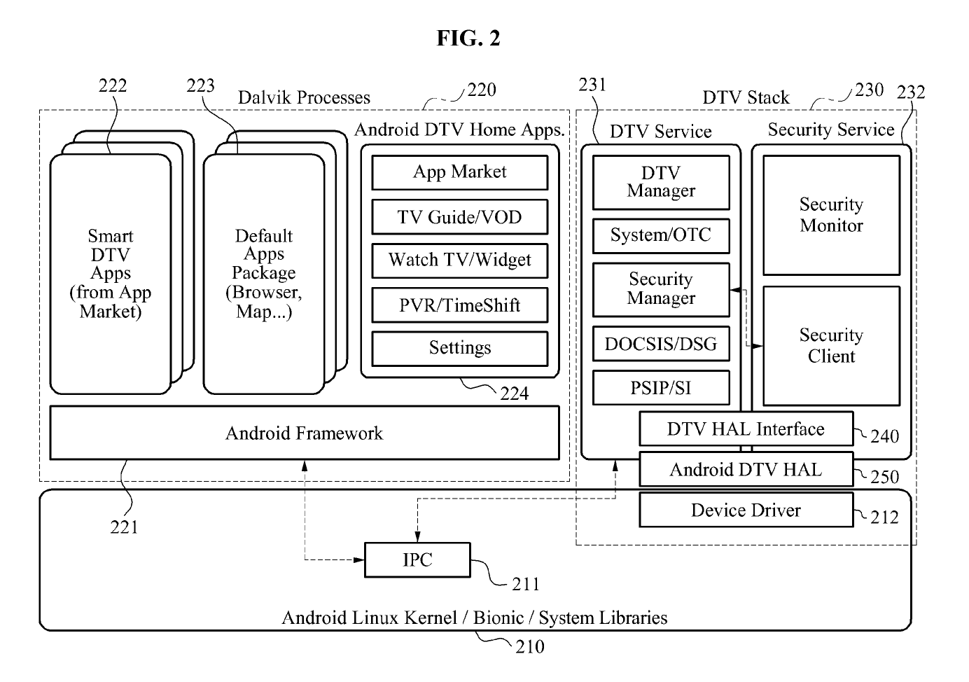

FIG. 2 illustrates a smart STB according to an embodiment of the present invention.

Referring to FIG. 2, the smart STB may operate based on an Android™ operating system 210.

The Android™ operating system 210 of FIG. 2, disposed on a first layer, may include a Linux® kernel, Bionic, system libraries, and a binder driver for an inter-process communication (IPC) 211. Here, both a DTV service and a smart service may be provided based on the single Android™ operating system 210. In this example, the Android™ operating system 210 may operate based on varied versions of Linux® kernel, for example, a Linux® kernel 2.6.

The Linux® kernel may operate first through a boot-loader when the smart STB is booted up, and the Android™ operating system 210 may perform an ‘init’ process that initializes a system after initializing a kernel.

The Android™ operating system 210 may include Bionic, that is, the C standard library (Libc). Bionic is a C library that is obtained by amending a Berkeley software distribution (BSD)-based libc to be suitable for a mobile environment, that is, an embedded environment, and may support services specified for Android. All native codes operating in the Android™ operating system 210 may be compiled using Bionic.

The Android™ operating system 210 may include a binder driver that performs an Android™ IPC mechanism. The IPC mechanism may refer to exchanging of data among processes. The Android™ operating system 210 may perform communication among processes of the Android™ operating system 210, for example, playback of a video, playback of an audio, use of a camera, management of activities, and the like, using the binder driver.

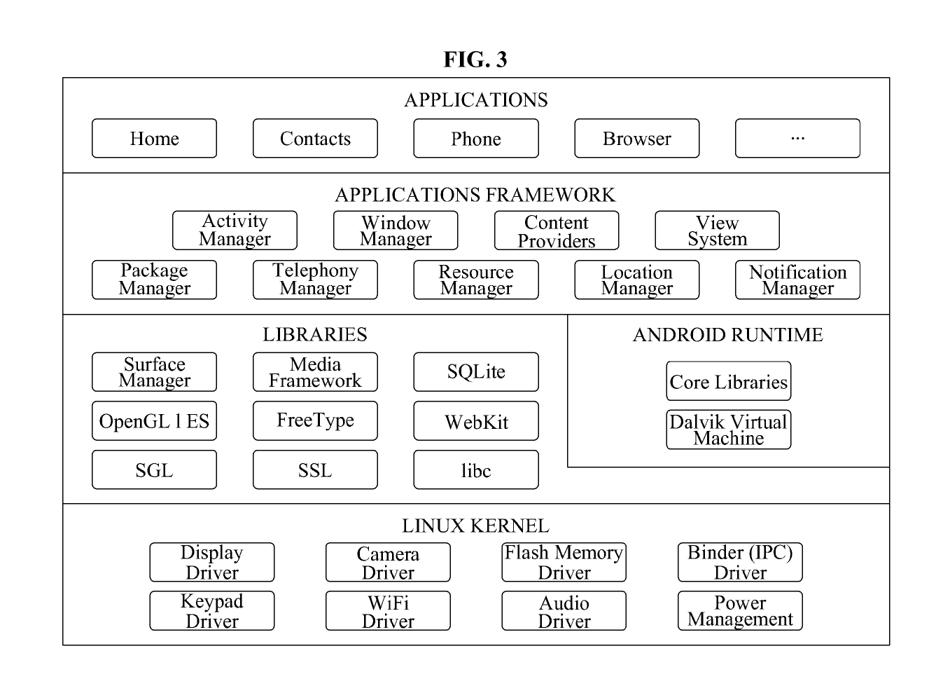

The Android™ operating system 210 will be described with reference to FIG. 3. The Linux® kernel manages a plurality of hardware devices, an internal memory, a processor, a networking, and the like, and the system libraries may be configured to include a Dalvik® virtual machine (DVM) and libraries to be used for utilizing a plurality of hardware devices to play back a graphic, a moving picture, and the like. Dalvik® is a registered trademark of Google Inc.

A security service module 232 included in a DTV stack 230, disposed on an upper layer of the first layer, may control a conditional-access of a user, in the Android™ operating system 210. For example, the security service module 232 may be embodied by eXchangeable Conditional Access System Secure Micro (XCAS SM).

The security service module 232 for the security service may include a security monitor, for example, an exchangeable conditional access system (XCAS) monitor, and a security client, for example, a conditional access system (CAS) client. The security service module 232 for the security service may provide a platform for executing the security client, for example, installing and updating of the security client, and providing of a security function.

The DTV stack 230 may provide the user with a DTV service included in the DTV stack 230 that provides a DTV service, in the Android™ operating system 210 based on qualifications of the user. In particular, the DTV stack 230 may insert a portion of a conventional STB that provides a DTV service, into an Android™ platform. The DTV stack 230 may provide a function of parsing and caching a DTV service broadcast information table, a function of connecting data over a cable service interface specification (DOCSIS) set-top gateway (DSG), a function of connecting interactive communication, for example, a cable modem or a local area network (LAN), a security function, for example, XCAS, a function of upgrading a system, and the like. To support the functions, a DTV service block 231 may include a DTV manager block, a system/OTC block, a security manager block, a DOCSIS/DSG block, a program specific information protocol/service information (PSIP/SI) block, and the like.

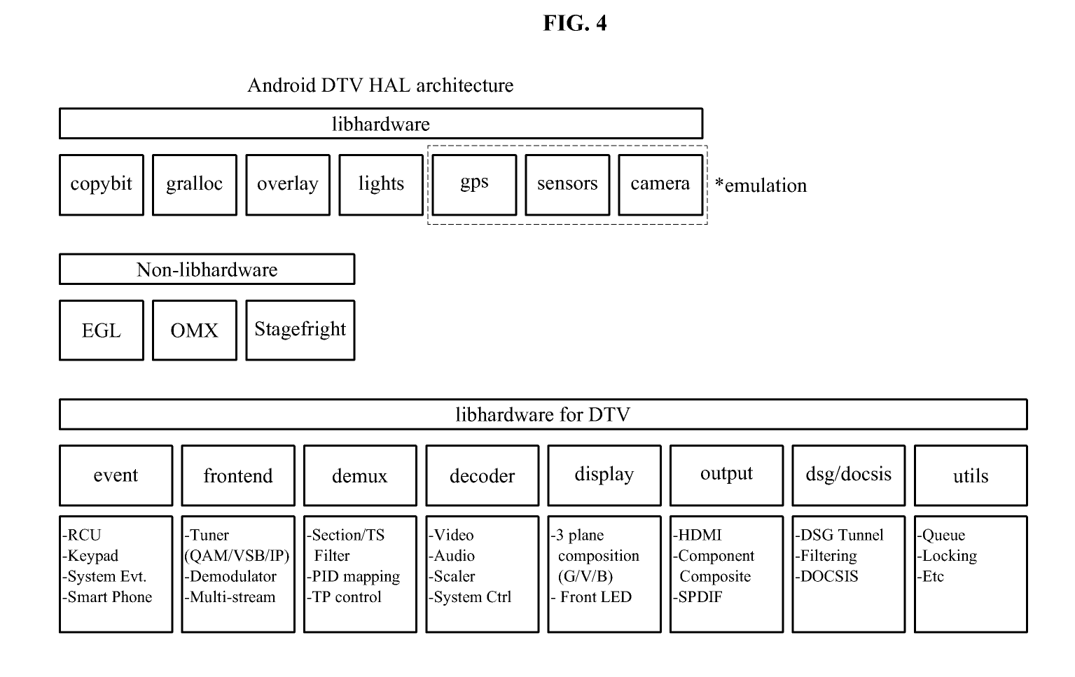

A hardware abstraction layer (HAL) 250 may allow the Android™ operating system 210 to communicate with the DTV stack 230 based on Android. Here, the DTV HAL 250 may be obtained by abstraction of an interface of a device driver 212. An example of the device driver 212 may include a Trident® device driver. Trident is a registered trademark of Trident Microsystems, Inc. The configuration of the DTV HAL 250 will be described with reference to FIG. 4.

The Android™ framework 221 may include an application programming interface (API) for applications. The Android™ operating system 211 may execute and load varied applications 222 and 223 using the Android™ framework 221.

The user may play back, through a DTV, an image associated with an Android™ application using the Android™ framework 221 through a Java® TV/home audio video interoperability (HAVi)/open cable application platform (OCAP) subset. That is, the Android™ framework 221 may provide DTV broadcast contents to the DVM on which the Android™ application operates.

The Java® TV/HAVi/OCAP subset may be middleware for providing the DTV service. In particular, a Java® TV may be a Java-based software framework for providing the DTV service, and may be an interface for a developer who develops software operating in an interactive TV service and a digital broadcast receiver. The HAVi may be middleware supporting data communication and the controlling of sound and imaging devices. The OCAP may be middleware for broadcasting data of an interactive host defined by CableLabs. The Java® TV/HAVi/OCAP subset may include a few APIs of the Java® TV, the HAVi, and the OCAP for supporting the DTV service and the Android™ application.

The smart STB may include the Android™ applications 222 and 223 implemented in the Android™ operating system 211. Here, the Android™ applications may include the basic applications 223, for example, Internet browser, a map, and the like, and applications 222 downloaded from an application market.

The application 222 may be a fused application of DTV broadcast contents and an Android™ application. Accordingly, the user may use varied Android™ applications along with DTV broadcast contents associated with corresponding applications, through the smart STB. The user may execute an Android™ application while receiving the DTV service through the smart STB.

The smart STB may download applications associated with a DTV service from an application market including a plurality of applications associated with the DTV service, based on selection of the user. Also, the smart STB may be able to download varied Android™ applications that are not associated with the DTV service.

A home screen of an Android™ DTV of the smart STB may include varied menus, for example, an ‘Application Market’ menu, a ‘TV guide’ menu, a ‘VOD’ menu, a ‘view TV’ menu, a ‘Widget’ menu, a ‘personal video recorder (PVR)’ menu, a ‘Time Shift’ menu, a ‘Settings’ menu, and the like.

For example, when the user selects the ‘Application Market’ menu, the smart STB may access an application market, and may download varied applications based on the selection of the user. When the user selects one of applications stored in the smart STB, the smart STB may execute the corresponding application.

The method of providing the smart service and the DTV service using the single Android™ operating system 210 has been described. The Android™ framework 221 may be allowed to communicate with the DTV service block 231 included in the DTV stack 230, through the binder driver that uses the IPC mechanism. That is, the embodiments of the present invention may provide the DTV service and the smart service in a single operating system, using the binder driver included in the operating system 210.

In this example, data exchanged during the communication between the Android™ framework 221 and the DTV service block 231 included in the DTV stack 230 may be encapsulated in a class for transmission and reception. In addition, a security manager of the DTV service block 231 and a security client of the security service module 232 may perform transmission and reception of data based on a socket communication scheme, and the security client may be embodied to be compatible with another CAS. Also, the DTV service block 231 and the security service module 232 may be embodied to operate irrespective of a specification of hardware and a type of hardware.

FIG. 3 illustrates a configuration of a system including a well-known Android™ operating system.

Referring to FIG. 3, the Android™ operating system may be configured to include four layers. A Linux® kernel 310 may manage networking in addition to managing of hardware devices, an internal memory, and processes. A library layer 320 based on C/C++ may be configured to include Dalvik® VM and a library for a plurality of hardware devices for playback of a graphic, a moving picture, and the like. An Android™ framework or an application framework 330 may provide a Java® API to be used for generating an application. An application layer 340 may be an upper-most layer in which applications developed by developers using an API of the application framework 330 are distributed and executed. An Android™ platform may be an open platform in which sources of all layers are open, and may be utilized for a smartphone, mainly.

As described in the foregoing, embodiments of the present invention may provide a unique platform for providing the smart service and the DTV service in the Android™ operating system.

FIG. 4 illustrates an architecture of an Android™ DTV HAL according to an embodiment of the present invention.

Referring to FIG. 4, the architecture of the Android™ DTV HAL may provide a DTV stack that is based on an Android™ operating system and that includes a DTV service and a security service, and may provide libraries for communication with the Android™ operating system, that is, a libhardware 410, a non-libhardware 420, and libhardware for DTV 430. In particular, the architecture of the Android™ DTV HAL may include the libhardware 410 corresponding to a library for hardware devices, the non-libhardware 420 corresponding to a library for non-hardware devices, and the libhardware for DTV 430 corresponding to a library for the DTV stack.

The libhardware 410 may be used for accessing a hardware device included in a smart STB of an Android™ system. The libhardware 410 may include a module associated with a graphic, a sensor, a global positioning system (GPS), a camera, or the like.

The non-libhardware 420 may include a module associated with the Android™ DTV HAL among modules that are excluded from the libhardware 410. For example, the non-libhardware 420 may include multi-media frameworks, such as, the electronic guarantee letter (EGL) framework, the OPenMAX (OMX) framework, the Stagefright framework. In particular, the EGL may be a native platform interface, and may define a glue interface layer function between a predetermined platform system and an OpenGL ES API. The OMX framework may be the standard API media interface of Khronos Group, and the stagefright framework may be a media framework created by Google®.

The libhardware for DTV 430 may include modules added for the DTV service, excluding the module included in the libhardware 410. The libhardware for DTV 430 may provide varied functions, for example, tuning of a DTV, zapping of a DTV, and the like, based on each module included in the libhardware for DTV 430. Each module included in the libhardware for DTV 430 of FIG. 4 may exist in a form of a library, and libraries of a DTV HAL may be stored in a location referred to by the Android™ framework so as to reuse the libraries used by the DTV stack. Accordingly, an Android™ application service utilizes the libraries.

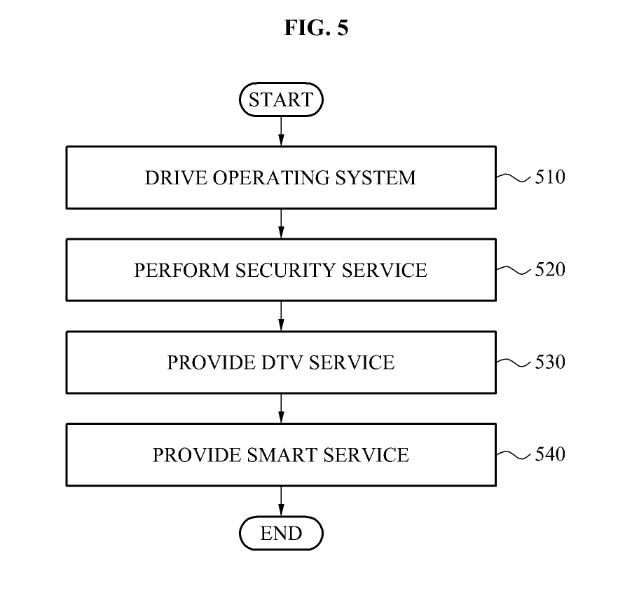

FIG. 5 illustrates a method of providing both a DTV service and a smart service according to an embodiment of the present invention.

Referring to FIG. 5, a smart STB may drive an operating system that includes at least a plurality of libraries and a kernel including a binder driver and drivers for a plurality of hardware devices in operation 510.

The smart STB may load a DTV stack including a DTV service function and a security service function in the operating system, and may perform a security service in operation 520. Accordingly, a conditional-access of a user may be controlled.

The smart STB may provide the user with a DTV service through the DTV stack that provides a DTV service in an Android™ operating system based on a qualification of the user in operation 530.

The smart STB may load applications designed based on an API of a framework corresponding to the operating system, in the operating system, and may execute at least one application so as to provide the user with a smart service in operation 540.

Embodiments of the present invention may also allow communication between at least one of the applications and the DTV stack when the at least one of the applications uses the binder driver included in the kernel of the operating system to access the DTV service function included in the DTV stack. In this example, a DTV HAL may be utilized to perform communication between the DTV service function and the security service function included in the DTV stack.

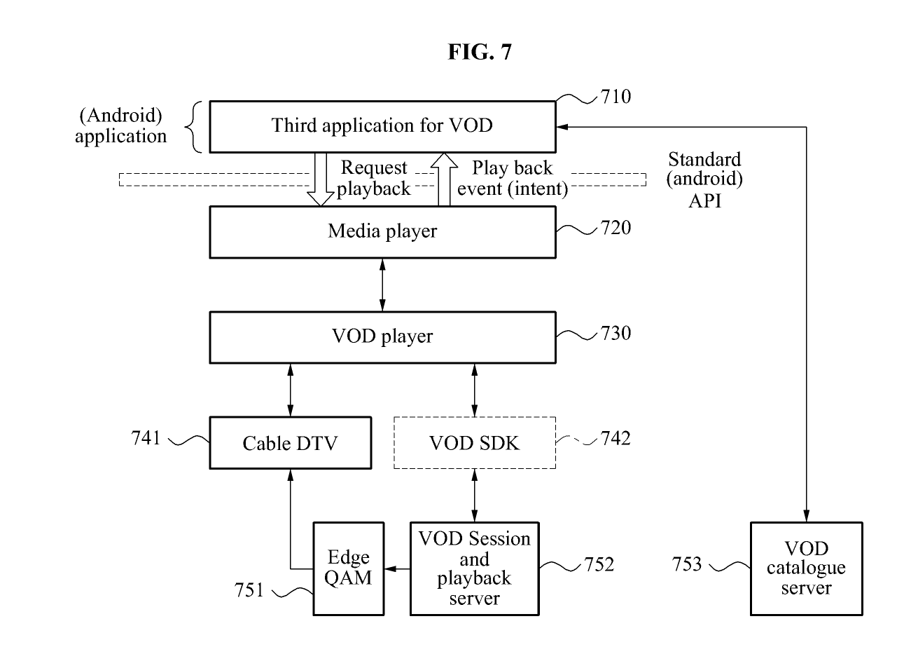

FIG. 7 illustrates a process that plays back VOD media data using a VOD player different from a default media player in an operating system according to an embodiment of the present invention.

Referring to FIG. 7, a single operating system that supports a smart service and a DTV service may include a default media player 720.

When a third application 710 that requests playback of VOD data exists, the third application 710 may transmit a playback request to the operating system, so as to request the playback of the VOD data. In this example, the default media player 720 may process the playback request.

Embodiments of the present invention may separately provide a VOD player 730 corresponding to an extended player different from the default media player 720. That is, the VOD player 730 may receive the playback request from the default media player 720, and may play back VOD media data provided from a cable TV 741 or a playback server 752 associated with a VOD software development kit (VOD SDK) 742. A route including the cable TV 741 may additionally include an edge quadrature amplitude modulation (QAM) module 751 for modulation and demodulation. Also, the VOD catalogue server 753 may provide, to the third application 710, asset information associated with each VOD which the third application 710 is able to access.

When a predetermined event occurs before the VOD player 720 plays back the VOD media data or while the VOD player 720 is playing back the VOD media data, information associated with content of the event may be transmitted to the third application 710. In this example, the default media player 720 may sense the occurrence of the event and may inform the third application 710 of the information associated with the content of the event through an API normally provided by the operating system. For example, the default media player 720 may broadcast the information associated with the content of the event while inserting the information associated with the event in an Intent class, and the third application 710 having an authority to receive the broadcasted information may suitably receive the information. The third application 710 may appropriately process the event based on the received information.

The type of event may vary. For example, the event may be a termination of playback of VOD data or an error in reception of VOD data. In addition, the event may be information associated with whether the conversion of a channel of VOD data is successfully performed or a cause of failure in channel conversion.

The VOD data of which playback is requested by the third application 710 may pass through the default media player 720 and may be played back by the VOD player 730. An event to be processed by the third application 710 or an event to be transmitted to the third application 710 may be transmitted to the third application 710 through the default media player 720. The information associated with the content of the event may be broadcasted while being inserted to the Intent class, and the third application 710 having an authority to receive the information may recognize the content of the event based on the information.

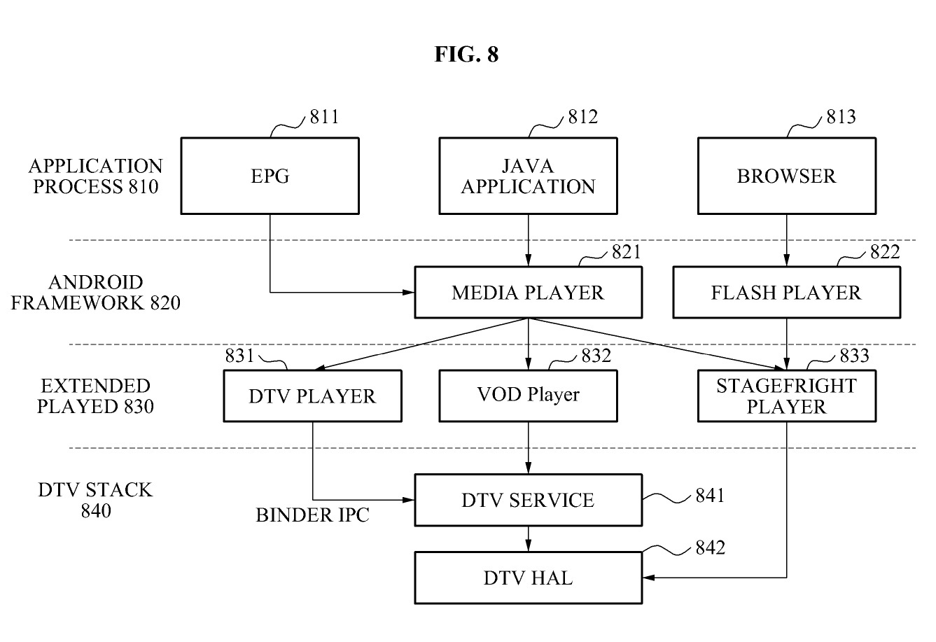

FIG. 8 illustrates a process that selects, by a default media player, an appropriate player based on an identifier (ID) of media data, and plays back the media data using the selected player according to an embodiment of the present invention.

Referring to FIG. 8, an application process 810 may be performed by an EPG 811 for a smart service or a DTV service, a Java® application 812, a browser 813.

When a request for playback of media data is transferred from the application process 810 to a single operating system, for example, an Android™ framework 820, a media player 821 or a flash player 822 typically included in the Android™ framework 820, may select an appropriate player from among extended players 830.

In particular, embodiments of the present invention may use a uniform resource identifier (URI) as an identifier (ID) of the media data, and may parse the URI. The ID may indicate a type of the media data, for example, VOD data, a flash file, and media data received through a cable channel. For example, when a front portion of the URI, or, depending on an embodiment, an end portion of the URI, includes ‘vod://’, the URI may indicate that the media data corresponds to VOD data. When the URI includes ‘sid://’, the URI may indicate that the media data corresponds to media data received through a cable channel. When the URI includes ‘swf’, the URI may indicate that the media data corresponds to a flash file.

The media player 821 or the flash player 822 may select one player from among the extended players 830 based on the type of the URI corresponding to the ID. When the URI includes ‘vod://’, the media player 821 or the flash player 822 may select a VOD player 832. When the URI includes ‘sid://’, the media player 821 or the flash player 822 may select a DTV player 831. When the URI includes ‘swf’, a media player 821 or the flash player 822 may select a Stagefright player 833.

A result of the playback of the media data may be provided to a DTV stack 840. In particular, when the media data is played back by the DTV player 831, the result of the playback may be provided to the DTV stack 840 using a binder driver included in a kernel of the single operating system. In this example, the binder driver included in the kernel of the single operating system may perform an IPC mechanism. In addition, a DTV HAL 842 may be utilized for communication between a DTV service function and a security service function included in the DTV stack 840.

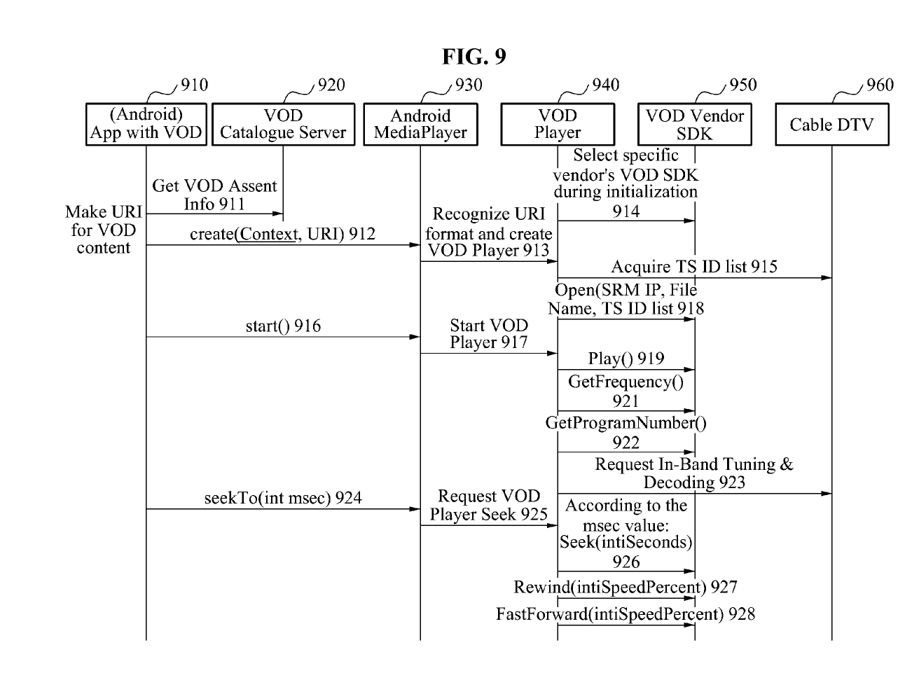

FIG. 9 illustrates a process that plays back VOD media data using a URI according to an embodiment of the present invention.

Referring to FIG. 9, an application 910 that requests playback of VOD data may obtain VOD asset information from a VOD catalogue server 920 in operation 911. The application 910 may generate a URI associated with the VOD content (VOD data), and may transmit a context and the URI to a media player 930 in operation 912.

The media player 930 may recognize that corresponding media data is VOD media data, and prepare to drive a VOD player 940 in operation 913. The VOD player 940 may select a VOD SDK 950 of a predetermined operator during initialization in operation 914. The VOD player may receive a list of transport stream IDs from a cable DTV stack 960 in operation 915. The VOD player 940 may open a scalable reliable multicast internet protocol (SRM IP), a file name, and a list of transport stream identifiers (TSIDs) in operation 918. Accordingly, the VOD player 940 completes preparation for playback of the VOD data.

When a start command is transmitted from the application 910 in operation 916, the media player 930 may be instructed to start driving of the VOD player 940 in operation 917. In this example, the VOD player 940 may transmit a playback request in operation 919, and may obtain a frequency for the corresponding media data in operation 921, and may obtain a program number in operation 922. In addition, the VOD player 940 may request, from the cable DTV stack 960, in-band tuning and decoding in operation 923. Accordingly, the playback of the VOD data by the VOD player may be maintained. Here, in-band tuning refers to isolating a physical media data from a stream of channels and converting it to a single signal.

In this example, when the application 910 desires to perform searching, for example, skipping, time-jump, adjusting of playback time, and the like, with respect to the VOD data in operation 924, a corresponding request may be transferred to the VOD player 940 via the media player 930. In this example, the VOD player 940 may perform the searching in operation 926, 927, or 928 in response to the request.

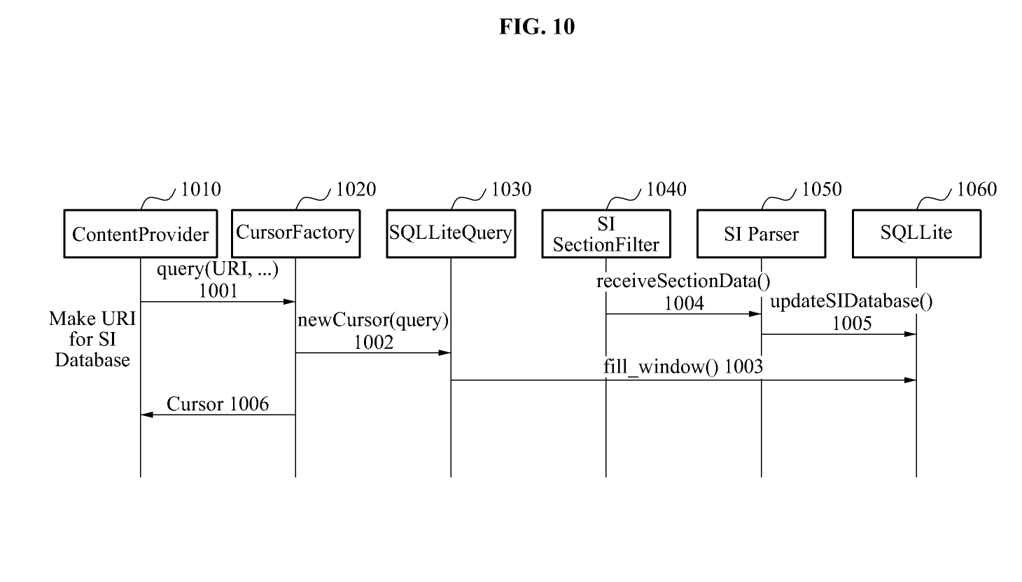

FIG. 10 illustrates a process that acquires service information through a content provider 1010 according to an embodiment of the present invention.

Embodiments of the present invention may generate a table for each section data output based on the standard specification, for example, digital video broadcasting/service information (DVB/SI), program and system information protocol/service information (PSIP/SI), and the like, by filtering and parsing the section data, and may update the table in an SQLLite 1060. An application that requests service information (SI), for example, an EPG and the like, may acquire desired SI using an URI through the content provider 1010, and may deliver the acquired data using a cursor.

Referring to FIG. 10, it is assumed that the SQLLite 1060 includes an SI database. The application may generate the URI so as to acquire the SI, and may transmit a query including the URI to a cursor factory 1020 through the content provider 1010 in operation 1001. The cursor factory 1020 may retransmit the query to a SQLLiteQuery 1030, and the SQLLiteQuery 1030 may execute a fill_window function with respect to the SOLLite 1060.

In addition, a service information section filter 1040 may transmit a section-filtering-performed section data to an SI parser 1050 in operation 1040, and the SI parser 1050 may update the SI in the SQLLite 1060 based on the section data.

Also, a response to the query of the cursor factory 1020 may be provided to the content provider 1010 in a form of a cursor.

A method of operating the smart STB has been described. The embodiments described in the foregoing with respect to FIGS. 1 through 4 may be applicable to the method of operating the smart STB and thus, detailed descriptions thereof will be omitted.

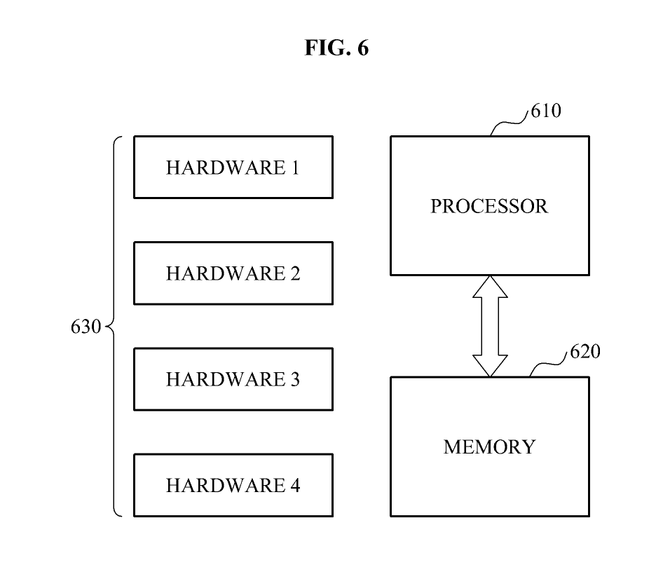

FIG. 6 illustrates a smart STB according to an embodiment of the present invention.

Referring to FIG. 6, the smart STB may include a processor 610, a memory 620, and a plurality of hardware devices 630. Here, the plurality of hardware devices 630 may include varied devices, for example, a keyboard, a tuner, a decoder, a modulator, network devices, sensors, and the like.

The processor 610 may drive an operating system including at least a plurality of libraries and a kernel including a binder driver and drivers for the plurality of hardware devices 630. In this example, in the operating system, applications designed based on an API of a framework corresponding to the operating system and a DTV stack including a DTV service function and a security service function may be loaded into the memory 620.

In this example, the processor 610 may allow communication between at least one of the applications and the DTV stack when the at least one of the applications uses the binder driver included in the kernel of the operating system to access the DTV service function included in the DTV stack. Accordingly, a smart service and the DTV service may be provided in a single operating system.

The embodiments described in the foregoing with reference to FIGS. 1 through 5 may be applicable to the smart STB of FIG. 6 and thus, detailed descriptions thereof will be omitted.

Although a few embodiments of the present invention have been shown and described, the present invention is not limited to the described embodiments. Instead, it would be appreciated by those skilled in the art that changes may be made to these to embodiments without departing from the principles and spirit of the invention, the scope of which is defined by the claims and their equivalents.

What is claimed is:

1. A method of playing back media data in a single operating system that supports a smart service and digital television (DTV) service, the method comprising:
loading, in a memory, the single operating system that supports the smart service and the DTV service;
receiving, by a default media player included in the single operating system from an application, a request for playback of a target media data;
determining, by the default media player, a type of an identifier (ID) of the target media data;
selecting, by the default media player based on the type of the ID of the target media data, one player between a video-on-demand (VOD) player and a DTV player different from the default media player; and
playing back the target media data by the selected player.

2. The method of claim 1, wherein the ID of the target media data comprises a uniform resource identifier (URI).

3. The method of claim 1, wherein the target media data is one of media data or a flash file received through a VOD channel or a DTV channel.

4. The method of claim 1, further comprising:
providing a result of the playback of the target media data to a DTV stack using a binder driver included in a kernel of the single operating system when the target media data is played back by the DTV player.

5. The method of claim 4, wherein the binder driver included in the kernel of the single operating system performs an inter-process communication (IPC) mechanism.

6. The method of claim 3, wherein the selecting comprises:
selecting one player from among the DTV player, the VOD player, and a new media framework player, based on the type of the ID of the target media data.

7. The method of claim 6, further comprising:
utilizing a DTV hardware abstraction layer (DTV HAL) for communication between a DTV service function and a security service function included in the DTV stack.

8. The method of claim 1, wherein the determining comprises:
determining the type of the ID of the target media data by parsing a predetermined front portion or a predetermined back portion of the ID.

9. A method of managing an event associated with playback in a single operating system that supports a smart service and a digital television (DTV) service, the method comprising:
receiving a playback request, by a default media player included in the single operating system from an application that requests playback of video-on-demand (VOD) data;
transmitting the playback request, by the default media player to a VOD player different from the default media player;
playing back, by the VOD player, the VOD data provided from a playback server; and
broadcasting, by the default media player, information associated with content of an event associated with the playback of the VOD data, in response to the event occurring.

10. The method of claim 9, wherein the broadcasting comprises:
inserting information associated with the content of the event into an Intent class.

11. The method of claim 9, wherein the information associated with the content of the event indicates at least one of termination of playback of the VOD data, error in reception of the VOD data, information associated with whether conversion of a channel of the VOD data is successfully performed, and a cause of failure in channel conversion.

12. The method of claim 9, wherein an authority to receive the information associated with the content of the event is assigned to the application.

13. A method of playing back media data in a single operating system that supports a smart service and a digital television (DTV) service, the method comprising:
loading, in a memory, the single operating system that supports the smart service and the DTV service;
obtaining, by an application, video-on-demand (VOD) asset information from a VOD catalogue server;
providing, by the application to a default media player included in the single operating system, an identifier (ID) indicating VOD data, in response to obtaining of the VOD asset information; and
selecting, by the default media player, a VOD player different from the default media player, based on the ID, so that the selected VOD player is driven.

14. The method of claim 13, further comprising:
obtaining, by the VOD player, a list of transport stream IDs; and
receiving, by the VOD player, corresponding VOD data from a playback server based on a transport stream ID, and decoding the received VOD data.

15. A non-transitory computer-readable medium comprising a program for instructing a computer to perform the method of:
loading, in a memory, the single operating system that supports the smart service and the DTV service;
receiving, by a default media player included in the single operating system from an application, a request for playback of a target media data;
determining, by the default media player, a type of an identifier (ID) of the target media data;
selecting, by the default media player based on the type of the ID of the target media data, one player between a video-on-demand (VOD) player and a DTV player different from the default media player; and
playing back the target media data by the selected player.

16. An apparatus for playing back media data in a single operating system that supports a smart service and a digital television (DTV) service, the apparatus comprising:
a memory in which the single operating system that supports the smart service and the DTV service is loaded; and
a processor to receive, by a default media player included in the single operating system, a request for playback of target media data from an application, and to determine a type of an identifier (ID) of the target media data,
wherein the processor selects one player between a video-on-demand (VOD) player and a DTV player different from the default media player based on the type of the ID of the target media data, and plays back the target media data using the selected player.

17. The apparatus of claim 16, wherein the processor selects one player from among the DTV player, the VOD player, and a new media framework player, based on the type of the ID of the target media data.

18. The apparatus of claim 16, wherein the apparatus comprises a DTV stack, and a result of the playback is provided to the DTV stack using a binder driver included in a kernel of the single operating system when the processors plays back the target media data using the DTV player.

19. The apparatus of claim 18, wherein the processor uses a DTV hardware abstraction layer (DTV HAL) for communication between a DTV service function and a security service function included in the DTV stack.
